(19) United States
(12) Patent Application Publication
(10) Pub. No.: US 2025/0245038 A1
(43) Pub. Date: Jul. 31, 2025

(54) DYNAMIC ESTABLISHMENT OF POLLING PERIODS FOR VIRTUAL MACHINE SWITCHING OPERATIONS

(71) Applicant: Intel Corporation, Santa Clara, CA (US)

(72) Inventors: Jaishankar Rajendran, Bengaluru, Karnataka (IN); Jun Nakajima, San Ramon, CA (US); Prashant B. Kodali, Portland, OR (US); Karthik R. Varadarajan, Bangalore, Karnataka (IN); Premanand Sakarda, Acton, MA (US); Zhiyuan Lv, Beijing (CN); Vaibhav Shankar, Lake Stevens, WA (US)

(73) Assignee: Intel Corporation, Santa Clara, CA (US)

(21) Appl. No.: 18/854,893

(22) PCT Filed: May 27, 2022
(86) PCT No.: PCT/CN2022/095542

§ 371 Date: Oct. 7, 2024

(51) Int. Cl. G06F 9/455

(52) U.S. Cl. CPC G06F 9/45558; G06F 2009/45591

(57) ABSTRACT

Dynamic establishment of polling periods for virtual machine switching operations is disclosed. An example of a process includes assigning a thread for a virtual machine (VM) to a virtual processor assigning the thread to a physical processor for processing; upon determining that the virtual processor is idle, dynamically determining a guest polling time value and performing polling of the virtual processor; and, upon receiving an interrupt prior to reaching the determined guest polling time value, returning the thread to processing. An example may further include receiving a VM exit at a virtual machine monitor (VMM); switching from the VM to VMM operation; dynamically determining a KVM (Kernel-based Virtual Machine) polling time value for the thread and performing polling of the virtual processor; and, upon receiving an interrupt prior to reaching the determined KVM polling time value, returning the thread to processing.

### FIELD

This disclosure relates generally to computing devices and more particularly to dynamic establishment of polling periods for virtual machine switching operations.

### BACKGROUND OF THE DISCLOSURE

In operation of virtual machines on a system, each virtual machine (VM) may operate on one or more separate virtual central processing units (vCPUs). During the processing of the virtual machines, idle conditions may occur, resulting in a halt of the respective vCPUs. This may be followed by switching between the virtual machines and a virtual machine monitor (VMM), the scheduling out of vCPUs for other purposes, and possible transition of physical processors to reduced power states. These operations can result in added latency in operation for processing threads.

A system may provide polling operations that can reduce the operations for virtual machines in certain circumstances. However, such polling operations are not tuned to a particular operation, and thus will often allow unnecessary switching operations.

### BRIEF DESCRIPTION OF THE DRAWINGS

So that the manner in which the above recited features of the present embodiments can be understood in detail, a more particular description of the embodiments, briefly summarized above, may be had by reference to embodiments, some of which are illustrated in the appended drawings. It is to be noted, however, that the appended drawings illustrate typical embodiments and are therefore not to be considered limiting of its scope. The figures are not to scale. In general, the same reference numbers will be used throughout the drawing(s) and accompanying written description to refer to the same or like parts.

FIG. 1 is an illustration of an apparatus or system for virtual processing, according to some embodiments;

FIG. 2 is an illustration of operations related to virtual machines, according to some embodiments;

FIG. 3 illustrates an example of an operation including guest polling for an idle virtual processor;

FIG. 4 illustrates an example of an operation including VMM polling for an idle virtual processor;

FIG. 5 is an illustration of dynamic modification of guest polling for an idle virtual processor, according to some embodiments;

FIG. 6 is an illustration of dynamic modification of VMM polling for an idle virtual processor, according to some embodiments;

FIG. 7 illustrates an example of a computing architecture for operations including dynamic modification of polling for virtual machines, according to some embodiments;

FIG. 8 is a block diagram of an example processor platform structured to execute machine readable instructions or operations, according to some embodiments;

FIG. 9 is a block diagram of an example implementation of processor circuitry; and

FIG. 10 is a block diagram illustrating an example software distribution platform.

### DETAILED DESCRIPTION

Implementations of the disclosure describe dynamic establishment of polling periods for virtual machine switching operations.

A virtual machine (VM) is a compute resource that uses software instead of a physical computer to run programs and deploy applications. One or more virtual “guest” machines may run on a physical “host” machine. Each virtual machine may run its own guest operating system and function separately from the other virtual machines, even when the virtual machines are running on a same host machine.

Virtual machines may be processed through operation of one or more virtual central processing units (vCPUs, which may also be referred to generally as virtual processors). In an operation, one or more vCPUs may be associated with each virtual machine. The threads within a virtual machine are then assigned to the vCPUs for processing. The threads assigned to vCPUs may generally be referred to as vCPU threads herein. To perform the processing, vCPU threads are then scheduled on one or more physical CPUs (pCPUs, which may also be referred to as physical processors, or simply as processors).

When a vCPU has no threads to process and is in idle state, the guest operating system may then send a request to halt (via an HLT instruction) the vCPU. Following the halt instruction, there will be a switch between the operation of the VM to operation of a virtual machine monitor (VMM). A VMM, also referred to as a hypervisor, is in general software that creates and runs virtual machines. The hypervisor is one of several hardware virtualization techniques that allow multiple operating systems, referred to as “guests”, to run concurrently on a host computer. The hypervisor is so named because it is conceptually one level higher than a supervisory program. The hypervisor presents to the guest operating systems a virtual operating platform and manages the execution of the guest operating systems. Multiple instances of a variety of operating systems may share the virtualized hardware resources in the system.

Following a switch from a VM to the VMM operation, the VMM may schedule out the vCPU, allowing another vCPU thread to run on the physical CPU in which the halted vCPU thread was running. In order to conserve power, physical CPUs are often transitioned into lower power sleep states of various types when the pCPUs are not active. If a physical CPU is idle following the scheduling out of the vCPU thread, the pCPU may be transitioned to such a lower power state to reduce power consumption.

However, there are performance costs in the switching between the VM and the VMM, in the scheduling out of a vCPU, and in the transition in and out of lower power states. Such operations create delays in reinstituting the processing of a vCPU thread on physical processor. Processors in a system may support APICv (Advanced Programmable Interrupt Controller Virtualization) that enables the system to introduce interrupts in a virtual machine without causing switching between the virtual machine and the VMM for MSR (Model-Specific Register) Writes for an ICR (Interrupt Command Register). If a wakeup interrupt is generated for a halted vCPU, the VMM is required to stop another vCPU thread running on the physical CPU. This will introduce a switching between VM and VMM to run the halted vCPU to process the interrupt. Switching between the VMM and the host, additional context switching, and wakeup IPI (Inter-Processor Interrupt) interrupts when crossing sockets are expensive in terms of performance costs. Physical CPU Idle and vCPU Idle conditions have significant performance differences. If there are frequent sleeps and wakeups for a physical processor, this will cause high levels of scheduling overhead, and the switching between VM and VMM will create performance costs.

In existing technology, Guest Halt Polling may be utilized to reduce switching between the VM and the VMM caused by HLT instruction execution. In this operation, instead of halting a vCPU immediately and causing a switch between VM and VMM, the VM is to poll the respective vCPU for a certain period of time, and during the polling period to wait for an interrupt for the vCPU to arrive. If the interrupt arrives during the polling time, the system can return to processing of the vCPU thread by the physical CPU without requiring switching between the VM and VMM. However, the guest polling time is a pre-set time value. In a large number of cases the polling time will elapse prior to receiving an interrupt, and a switching between VM and VMM will occur as a result of the HLT instruction. This results in additional overhead due to additional context switching and expensive wake up interrupts. Further, this issue will scale up when the number of vCPUs executing HLT instructions is large.

Following a VM exit to the VMM due to the HLT, KVM (Kernel-based Virtual Machine) Halt Polling may also be performed to reduce context switches and interrupts due to HLT instruction execution. In this operation, instead of scheduling out the vCPU immediately and triggering a context switch in the physical CPU, the VMM will poll for a certain time period and wait for an interrupt for the vCPU to arrive, and thus potentially delay a context switch operation. However, the KVM polling time is a pre-set time period, and in many cases the polling time will elapse and result in a scheduling out of the vCPU, creating overhead due to additional context switching and expensive wake up interrupts. The issue will again scale up when the number of vCPUs executing HLT instructions is large.

In some embodiments, an apparatus, system, or process provides a dynamic means of determining a guest polling time, where the determination is based on power management unit (PMU) counters of C-state (i.e., reduced power state) residency. By dynamically determining an optimal Guest Halt polling time, a VM is able to poll the vCPU for an extended time and wait for an interrupt for the vCPU to arrive. This operation can reduce unnecessary switching between VM and VMM, and thus improve the performance of the VM.

In some embodiments, an apparatus, system, or process further provides a dynamic means of determining a KVM polling time based on a classification of vCPU threads. By identifying an optimal KVM polling time based on the classification of the thread, the VMM is able to poll the vCPU for an extended time and wait for an interrupt for the vCPU to arrive. This operation can reduce the number of unnecessary context switches, and thus further improve the performance of the VM.

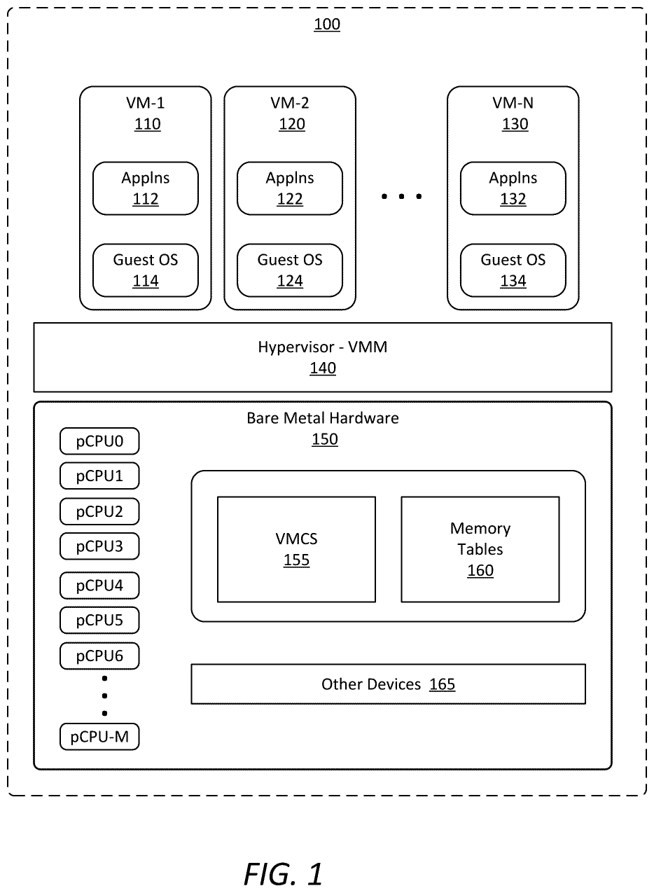

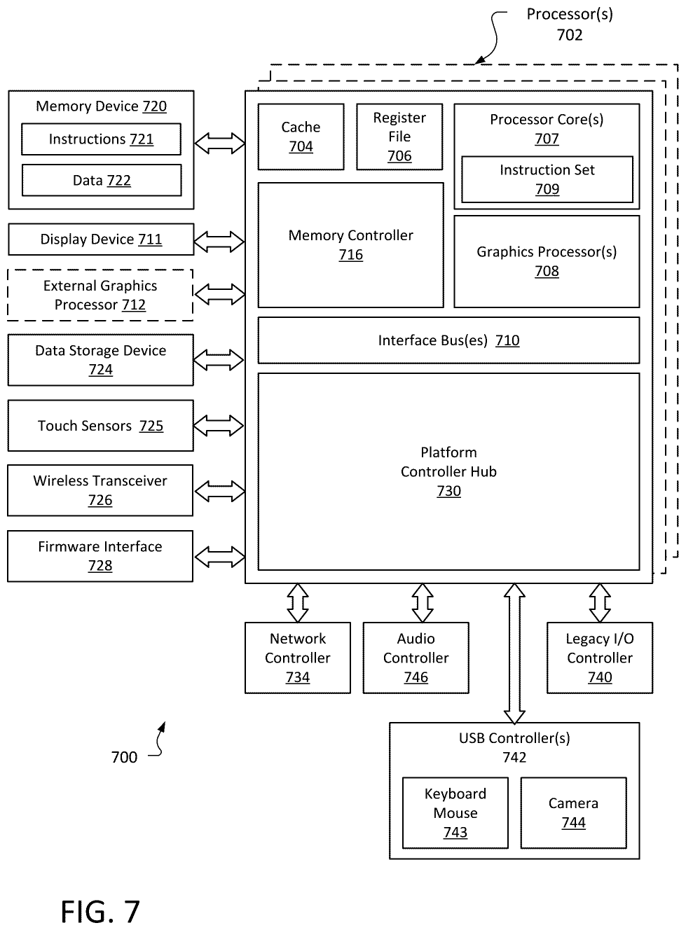

FIG. 1 is an illustration of an apparatus or system for virtual processing, according to some embodiments. In this illustration, an apparatus or system 100 for virtual processing includes bare metal hardware 150 (where bare metal refers to a computer executing instructions directly on logic hardware without an intervening operating system) including multiple physical processors, shown as pCPU0 through pCPU7-M (wherein M may be any number), for the processing of data. Any number of physical processors (such as pCPUs) may be included in a system. The processing may include processing of vCPU threads for one or more virtual processors. The apparatus or system further includes a virtual machine control structure (VMCS) 155 to provide support for operation of virtual machines, and memory tables 160 to store data connected with VM operation. The bare metal hardware may further include other devices 165, wherein additional details regarding the apparatus or system 100 are illustrated in in FIGS. 7-9.

In the example illustrated in FIG. 1, the apparatus or system 100 provides processing support for multiple virtual machines, such as the illustrated VM-1 110, VM-2 120, and continuing to VM-N 130 (where N may be any number). Any number of virtual machines may be supported by the apparatus or system 100. Each of the virtual machines may include one or more applications, and may include a separate guest operating system, where the operating systems may vary between virtual machine instances. For example, VM-1 110 includes applications 112 and guest OS 114, VM-2 120 includes applications 122 and guest OS 124, and VM-3 130 includes applications 132 and guest OS 134.

In processing, each virtual machine may be assigned to one or more virtual CPUs, with the processing for each active virtual machine being assigned to a physical CPU. Upon the virtual CPUs reaching idle states, halt instructions will be issued, which may result in a virtual machine exit and scheduling out of the respective vCPUs to allow for scheduling of other vCPU threads to the physical processors, or for a physical processor to transition to a lower power state.

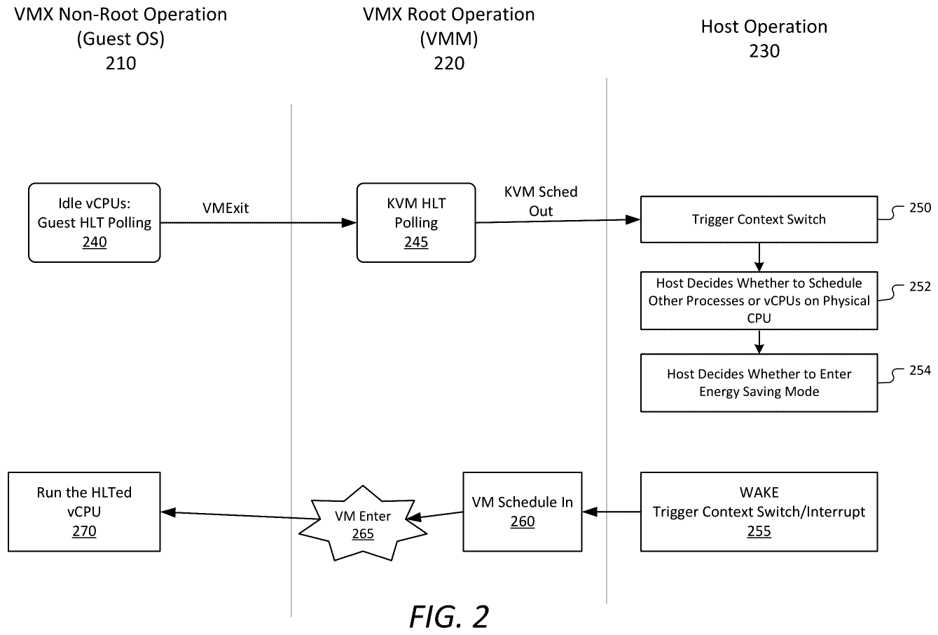

FIG. 2 is an illustration of operations related to virtual machines, according to some embodiments. FIG. 2 illustrates VMX (Virtual Machine Extensions) non-root operations (relating to a guest OS operation for a virtual machine) 210, VMX root operations (relating to the VMM/hypervisor) 220, and host operation 230.

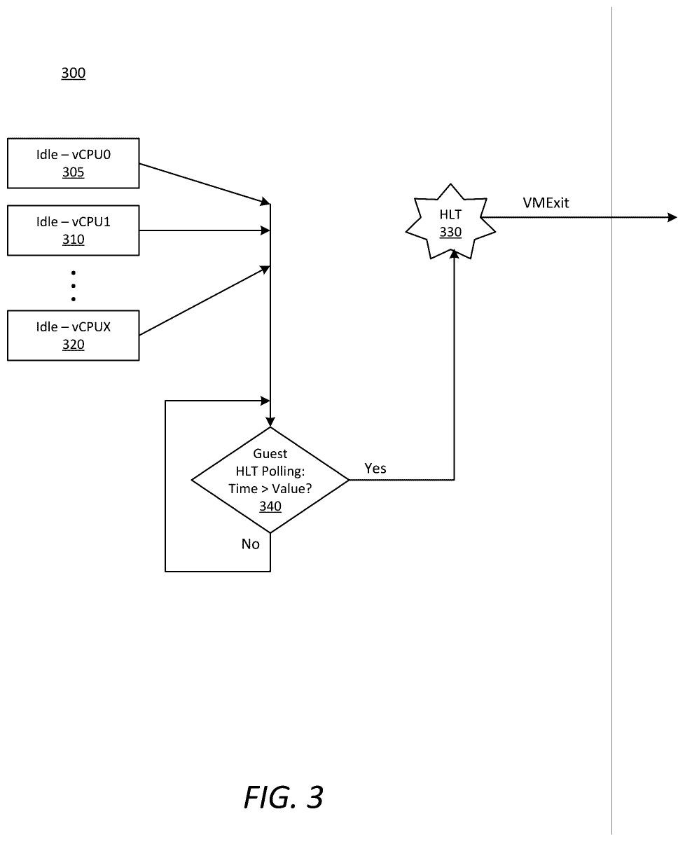

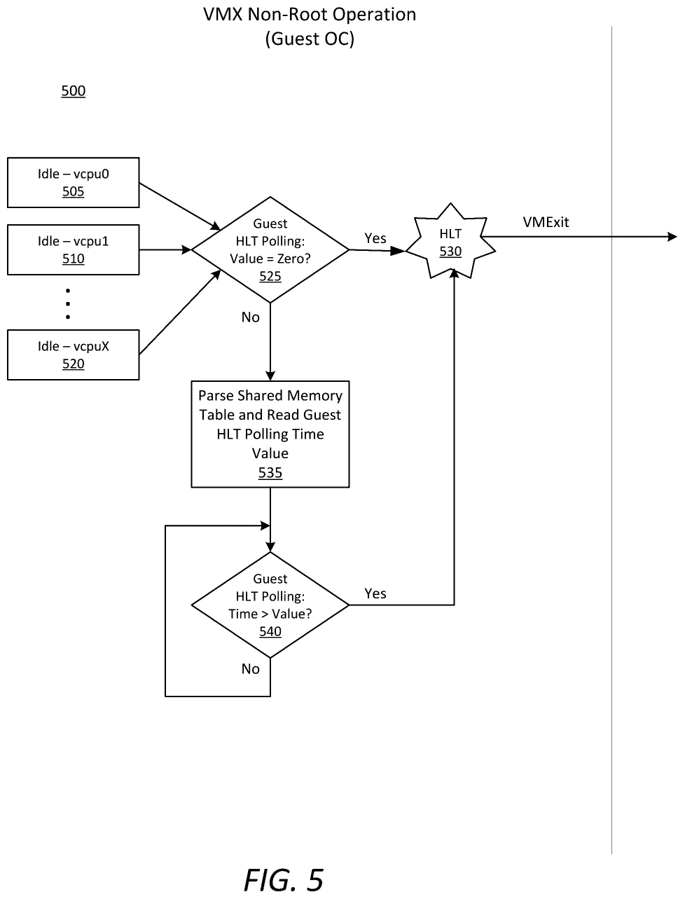

In an operation, virtual threads of vCPUs are assigned to one or more physical CPUs for processing. At a high level, upon a thread on a vCPU becoming idle, guest HLT polling is performed 240 in the guest OS operation 210, and, if the guest polling time expires prior to receiving an interrupt, there is a virtual machine exit (VMExit). Further details are illustrated in FIGS. 3 and 5.

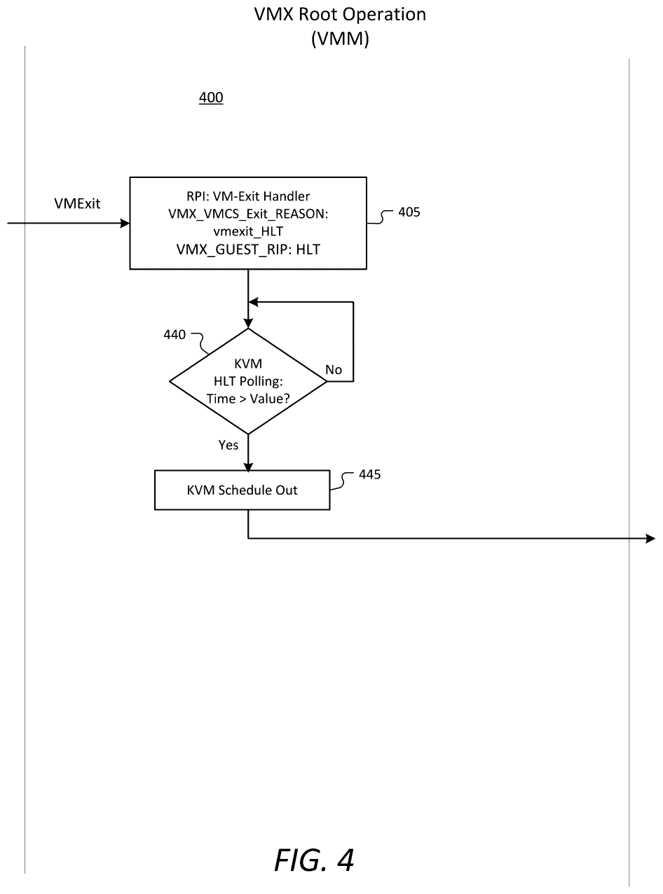

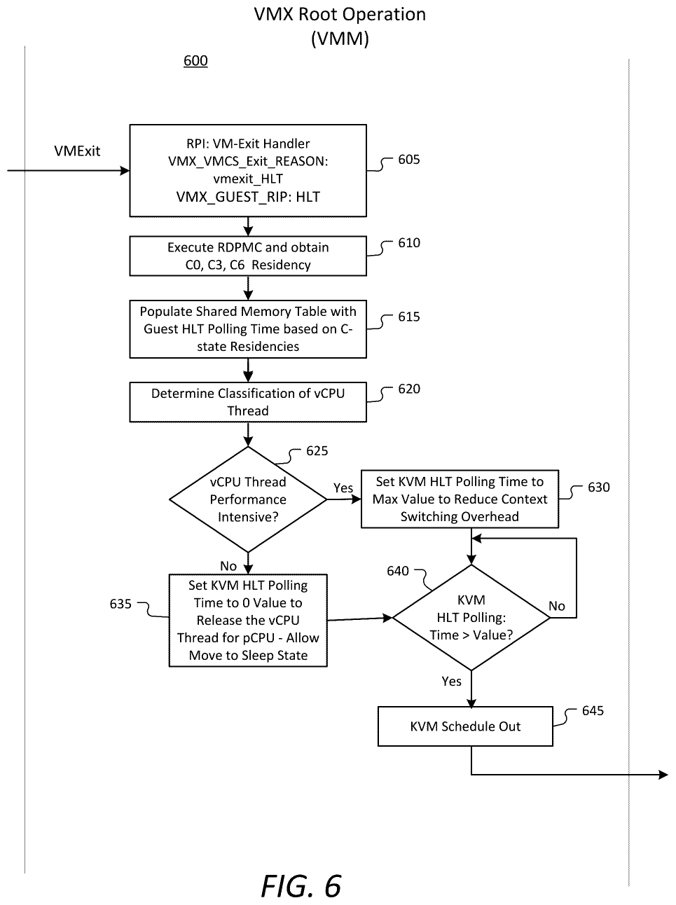

The VMExit results in a switch to VMM operation 220, in which there is a KVM HLT polling 245. Upon the KVM polling time expiring prior to an interrupt, there is a KVM schedule out of the vCPU to the host machine operation 230. Further details are illustrated in FIGS. 4 and 6.

In the host operation 230, the scheduling out of the vCPU may result in triggering a context switch for the vCPU 250. The host is to determine whether to schedule one or more other processes or vCPUs on the relevant physical CPU 252. Further, the host is to decide whether to transition the physical CPU to an energy saving mode (C-mode) if the processor is idle for sufficient period of time, depending on the power saving mode requirements.

In continued operation, the processor may be returned to processing of a vCPU thread. Upon receipt of a Wake command, a context switch or interrupt is triggered 255. This results in scheduling in the virtual machine 260, and a virtual machine enter 265. A switch between the VMM and VM may then occur, resulting in again running the halted vCPU 270 on the physical processor.

In some embodiments, the guest HLT polling 240 and KVM HLT polling 245 operations are to be dynamically modified for vCPU processing to optimize the polling times for such operations, and to reduce unnecessary VM exits and scheduling out that have a negative impact on system performance.

FIG. 3 illustrates an example of an operation including guest polling for an idle virtual processor. In a process 300, upon one or more virtual CPUs entering idle states over a period of time, such as the illustrated vCPU0 305, vCPU1 310, and continuing through vCPUX 320, instead of halting the vCPUs immediately and causing a switch between VM and VMM, the VM is to poll the respective vCPU for a certain period of time, and during the polling period to wait for an interrupt for the vCPU to arrive.

In an operation, the guest HLT polling 340 includes polling until a time period is greater than a pre-set polling time value. Upon the polling time expiring, there is then a HLT 330 of the vCPU, resulting in a VM Exit. However, in a conventional operation the guest polling time is a predetermined time period, and does not reflect the current conditions for an apparatus or system.

FIG. 4 illustrates an example of an operation including VMM polling for an idle virtual processor. In a process 400, upon a virtual CPU being halted, resulting in a VM Exit, such as illustrated in FIG. 3, a VM-Exit handler processes the exit as resulting from the halt of the vCPU 405. The KVM HLT polling by the VMM then proceeds for a certain time value 440, while waiting for an interrupt for the vCPU to arrive.

If the polling time expires (i.e., the elapsed polling time is greater than the polling time value) before receipt of the interrupt, there is then a KVM schedule out of vCPU, and processing by the host system (as illustrated in FIG. 2) proceeds. However, in a conventional operation, the KVM polling time is a predetermined time period, and does not reflect the current conditions for an apparatus or system.

FIG. 5 is an illustration of dynamic modification of guest polling for an idle virtual processor, according to some embodiments. In some embodiments, in a process 500, upon one or more virtual CPUs entering idle states over a period of time, such as the illustrated vCPU0 505, vCPU1 510, and continuing through vCPUX 520, instead of halting the vCPUs immediately and causing a switch between VM and VMM, the VM is to initially determine whether the guest HLT polling time value equals zero 525, which may occur with an initial idle vCPU. If the value equals zero, then there is halt of the vCPU 530, resulting in a VMExit to the VMM, which is illustrated in FIG. 6.

However, if the polling time value is not zero 525, then the process 500 proceeds with parsing a shared memory table (such as a table within memory tables 160 illustrated in FIG. 1), and reading the guest HLT polling time value from the table 535. The establishment of the values in the shared memory table may be based on C-mode residency values, as illustrated in FIG. 6.

In this operation, upon another idle vCPU thread arriving, before executing an HLT Instruction, an apparatus or system will read the guest polling time from the shared memory table, and VM will poll for that period and wait for the interrupt. If this elapses, the guest polling time is re-configured based on reading the C-stated residency values (using an RDPMC (Read Performance-Monitoring Counters) instruction) by switching VM to VMM. The procedure is then followed for each succeeding idle vCPU thread. In this manner, the number of VM exits due to HLT may be reduced, and the system performance thus improved. This approach of determining Guest HLT polling time will be more optimal and will reduce the switching between VM and VMM caused by HLT events.

In some embodiments, the VM then performs the polling operation until the polling time is greater than the determined polling time value 540, and during the polling period to wait for an interrupt for the vCPU to arrive. If the polling time expires (polling time is greater than the time value), then there is halt of the vCPU 530, resulting in a VM Exit to the VMM.

FIG. 6 is an illustration of dynamic modification of VMM polling for an idle virtual processor, according to some embodiments. In some embodiments, in a process 600, upon a virtual CPU being halted and resulting in a VM Exit, such as illustrated in FIG. 5, a VM-Exit handler processes the exit as resulting from the halt of the vCPU 605. In some embodiments, the VM Exit is trapped, and C-mode residency values are read, such as using execution of a RDPMC (Read Performance-Monitoring Counters) instruction 610.

Residency values refer to times that a processor is within a particular C-state. C-states range from C0 to Cn (where n is a particular integer value), with C0 indicating an active state, and other C-states (C1-Cn) representing idle sleep states in which the processor is inactive and different parts of the processor are powered down. As the C-states become deeper, the power savings becomes greater, but the exit latency duration (the time to transition to C0) also becomes longer. In a particular implementation, a set of C-state residency values, such as C0, C3, and C6 residency values, are read and the guest polling time is established based on the residency indicated in shared memory tables. For example, if a number of processor cores are in C6 (a deeper power state), this indicates that the pCPUs are not busy, and the VM may then be provided a longer guest polling time during which to wait for the IPI interrupt. If the processor cores are instead resident in higher power states (C3 and C0 in this example), this indicates that the processors are busier, and a shorter guest polling time may be established. The shared memory table is populated with one or more guest HLT polling times based on the C-state residencies 615, and the guest polling times may be read from the shared memory table, such as illustrated in element 535 of FIG. 5.

In some embodiments, the process 600 further provides a dynamic means of determining a KVM polling time based on a classification of threads. The process continues with reading a classification of the vCPU thread 620, where the classification may include whether the vCPU thread is performance intensive. In some embodiments, the classification of threads may be determined using, for example, hardware guided scheduling+ (HGS+), in which the thread classification is read from the HFI (Hardware Feedback Interface) structure or other thread classification data structure. By identifying an appropriate KVM polling time based on the classification of the thread, the VMM is able to poll the vCPU for an extended time and wait for an interrupt for the vCPU to arrive.

In a first example, upon a determination that the vCPU thread is performance intensive 625, the KVM HLT polling time may be set to a maximum value (or other high value) to reduce context switching overhead 630. If the interrupt arrives during the polling time, this will help the vCPU thread to continue executing on the same pCPU.

In a second example, upon a determination that the vCPU thread is not performance intensive 625, the KVM HLT polling time may be set to zero (or other lower value) in order to expedite the scheduling out of the vCPU thread for the pCPU 635. In this manner, the physical processor then may be allowed to more quickly transition to a sleep state, as needed. While these examples are limited to a polling time value being set to either a maximum (higher) time value or a zero (lower) time value, depending on the performance intensiveness of the thread, embodiments are not limited to these particular values, and may be set to other values depending on the determined classification of the vCPU thread.

The KVM HLT polling by the VMM then proceeds 640 for a certain period of time until reaching the established polling time value, while waiting for an interrupt for the vCPU to arrive. Upon the polling time being greater than the established polling time value (being either zero or a maximum value in this example), there is a KVM schedule out 645 to the host system.

FIG. 7 illustrates an example of a computing architecture for operations including dynamic modification of polling for virtual machines, according to some embodiments. In various embodiments as described above, a computing architecture 700 may comprise or be implemented as part of an electronic device.

In some embodiments, the computing architecture 700 may be representative, for example, of a computer system that implements one or more components of the operating environments described above. The computing architecture 700 may be utilized to provide dynamic establishment of polling periods for virtual machine switching operations, such as described in FIGS. 1-6.

As used in this application, the terms “system” and “component” and “module” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive or solid state drive (SSD), multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the unidirectional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 includes one or more processors 702 and one or more graphics processors 708, and may be a single processor desktop system, a multiprocessor workstation system, or a server system having a large number of processors 702 or processor cores 707. In one embodiment, the system 700 is a processing platform incorporated within a system-on-a-chip (SoC or SOC) integrated circuit for use in mobile, handheld, or embedded devices.

An embodiment of system 700 can include, or be incorporated within, a server-based gaming platform, a game console, including a game and media console, a mobile gaming console, a handheld game console, or an online game console. In some embodiments system 700 is a mobile phone, smart phone, tablet computing device or mobile Internet device. Data processing system 700 can also include, couple with, or be integrated within a wearable device, such as a smart watch wearable device, smart eyewear device, augmented reality device, or virtual reality device. In some embodiments, data processing system 700 is a television or set top box device having one or more processors 702 and a graphical interface generated by one or more graphics processors 708.

In some embodiments, the one or more processors 702 each include one or more processor cores 707 to process instructions which, when executed, perform operations for system and user software. In some embodiments, each of the one or more processor cores 707 is configured to process a specific instruction set 709. In some embodiments, instruction set 709 may facilitate Complex Instruction Set Computing (CISC), Reduced Instruction Set Computing (RISC), or computing via a Very Long Instruction Word (VLIW). Multiple processor cores 707 may each process a different instruction set 709, which may include instructions to facilitate the emulation of other instruction sets. Processor core 707 may also include other processing devices, such a Digital Signal Processor (DSP).

In some embodiments, the processor 702 includes cache memory 704. Depending on the architecture, the processor 702 can have a single internal cache or multiple levels of internal cache. In some embodiments, the cache memory 704 is shared among various components of the processor 702. In some embodiments, the processor 702 also uses an external cache (e.g., a Level-3 (L3) cache or Last Level Cache (LLC)) (not shown), which may be shared among processor cores 707 using known cache coherency techniques. A register file 706 is additionally included in processor 702 which may include different types of registers for storing different types of data (e.g., integer registers, floating point registers, status registers, and an instruction pointer register). Some registers may be general-purpose registers, while other registers may be specific to the design of the processor 702.

In some embodiments, one or more processor(s) 702 are coupled with one or more interface bus(es) 710 to transmit communication signals such as address, data, or control signals between processor 702 and other components in the system. The interface bus 710, in one embodiment, can be a processor bus, such as a version of the Direct Media Interface (DMI) bus. However, processor buses are not limited to the DMI bus, and may include one or more Peripheral Component Interconnect buses (e.g., PCI, PCI Express), memory buses, or other types of interface buses. In one embodiment the processor(s) 702 include an integrated memory controller 716 and a platform controller hub 730. The memory controller 716 facilitates communication between a memory device and other components of the system 700, while the platform controller hub (PCH) 730 provides connections to I/O devices via a local I/O bus.

Memory device 720 can be a dynamic random-access memory (DRAM) device, a static random-access memory (SRAM) device, non-volatile memory device such as flash memory device or phase-change memory device, or some other memory device having suitable performance to serve as process memory. Memory device 720 may further include non-volatile memory elements for storage of firmware. In one embodiment the memory device 720 can operate as system memory for the system 700, to store data 722 and instructions 721 for use when the one or more processors 702 execute an application or process. Memory controller hub 716 also couples with an optional external graphics processor 712, which may communicate with the one or more graphics processors 708 in processors 702 to perform graphics and media operations. In some embodiments a display device 711 can connect to the processor(s) 702. The display device 711 can be one or more of an internal display device, as in a mobile electronic device or a laptop device, or an external display device attached via a display interface (e.g., DisplayPort, etc.). In one embodiment the display device 711 can be a head mounted display (HMD) such as a stereoscopic display device for use in virtual reality (VR) applications or augmented reality (AR) applications.

In some embodiments the platform controller hub 730 enables peripherals to connect to memory device 720 and processor 702 via a high-speed I/O bus. The I/O peripherals include, but are not limited to, an audio controller 746, a network controller 734, a firmware interface 728, a wireless transceiver 726, touch sensors 725, a data storage device 724 (e.g., hard disk drive, flash memory, etc.). The data storage device 724 can connect via a storage interface (e.g., SATA) or via a peripheral bus, such as a Peripheral Component Interconnect bus (e.g., PCI, PCI Express). The touch sensors 725 can include touch screen sensors, pressure sensors, or fingerprint sensors. The wireless transceiver 726 can be a Wi-Fi transceiver, a Bluetooth transceiver, or a mobile network transceiver such as a 3G, 4G, Long Term Evolution (LTE), or 5G transceiver. The firmware interface 728 enables communication with system firmware, and can be, for example, a unified extensible firmware interface (UEFI). The network controller 734 can enable a network connection to a wired network. In some embodiments, a high-performance network controller (not shown) couples with the interface bus 710. The audio controller 746, in one embodiment, is a multi-channel high definition audio controller. In one embodiment the system 700 includes an optional legacy I/O controller 740 for coupling legacy (e.g., Personal System 2 (PS/2)) devices to the system. The platform controller hub 730 can also connect to one or more Universal Serial Bus (USB) controllers 742 connect input devices, such as keyboard and mouse 743 combinations, a camera 744, or other USB input devices.

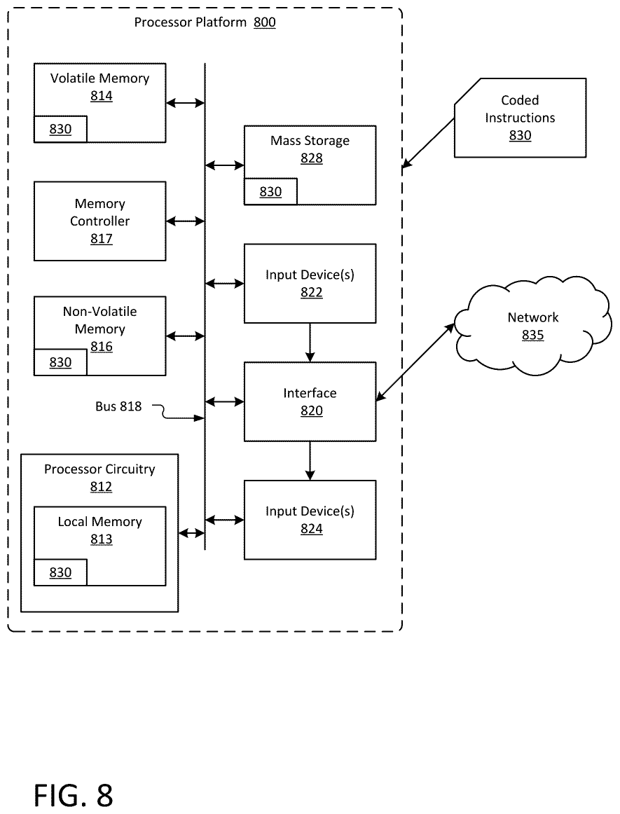

FIG. 8 is a block diagram of an example processor platform structured to execute machine readable instructions or operations, according to some embodiments. As illustrated, a processor platform 800 can be, for example, a server, a personal computer, a workstation, a self-learning machine (e.g., a neural network), a mobile device (e.g., a cell phone, a smart phone, or a tablet), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 800 of the illustrated example includes processor circuitry 812. The processor circuitry 812 of the illustrated example is hardware. For example, the processor circuitry 812 can be implemented by one or more integrated circuits, logic circuits, FPGAs, microprocessors, CPUs, GPUs, DSPs, and/or microcontrollers from any desired family or manufacturer. The processor circuitry 812 may be implemented by one or more semiconductor based (e.g., silicon based) devices.

The processor circuitry 812 of the illustrated example includes a local memory 813 (e.g., a cache, registers, etc.). The processor circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), Dynamic Random Access Memory, and/or any other type of RAM device. The non-volatile memory 816 may be implemented by flash memory and/or any other desired type of memory device. Access to the main memory 814, 816 of the illustrated example is controlled by a memory controller 817.

The processor platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 822 are connected to the interface circuitry 820. The input device(s) 822 permit(s) a user to enter data and/or commands into the processor circuitry 812. The input device(s) 822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 are also connected to the interface circuitry 820 of the illustrated example. The output devices 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 835. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 800 of the illustrated example also includes one or more mass storage devices 828 to store software and/or data. Examples of such mass storage devices 828 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 830, which may be implemented by the machine readable instructions of FIG. 7, may be stored in the mass storage device 828, in the volatile memory 814, in the non-volatile memory 816, and/or on a removable non-transitory computer readable storage medium such as a CD or DVD.

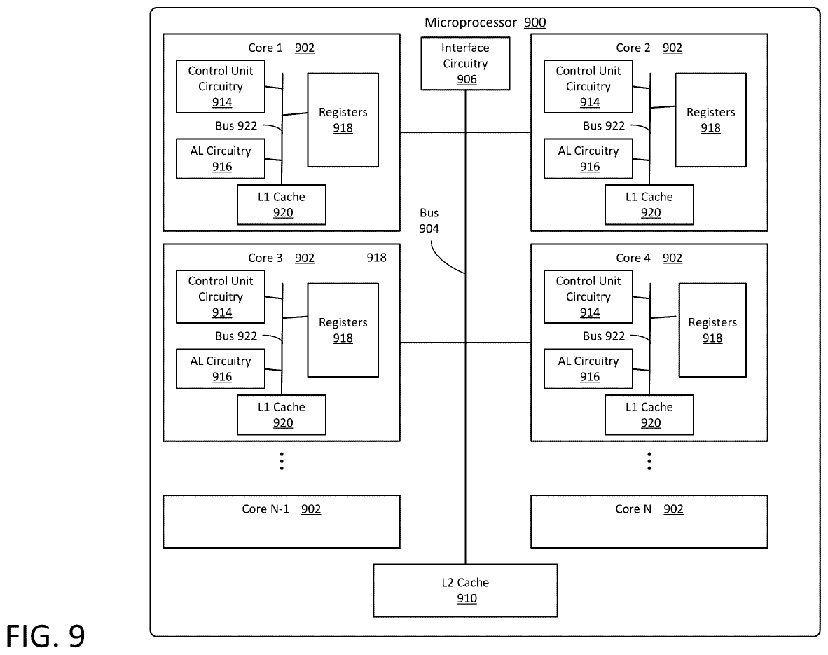

FIG. 9 is a block diagram of an example implementation of processor circuitry. In this example, the processor circuitry is implemented by a microprocessor 900. For example, the microprocessor 900 may implement multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts in FIGS. 2-6.

The cores 902 may communicate by an example bus 904. In some examples, the bus 904 may implement a communication bus to effectuate communication associated with one(s) of the cores 902. For example, the bus 904 may implement at least one of an Inter-Integrated Circuit (I2C) bus, a Serial Peripheral Interface (SPI) bus, a PCI bus, or a PCIe bus. Additionally or alternatively, the bus 904 may implement any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2) cache) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory. Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the L1 cache 920, and an example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating point operations. In yet other examples, the AL circuitry 916 may include first AL circuitry that performs integer based operations and second AL circuitry that performs floating point operations. In some examples, the AL circuitry 916 may be referred to as an Arithmetic Logic Unit (ALU). The registers 918 are semiconductor-based structures to store data and/or instructions such as results of one or more of the operations performed by the AL circuitry 916 of the corresponding core 902. For example, the registers 918 may include vector register(s), SIMD register(s), general purpose register(s), flag register(s), segment register(s), machine specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure including distributed throughout the core 902 to shorten access time. The bus 904 may implement at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

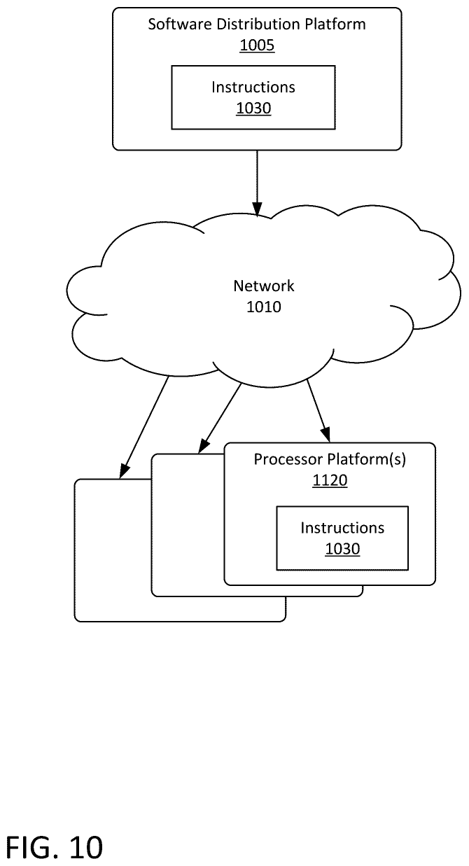

FIG. 10 is a block diagram illustrating an example software distribution platform. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store machine readable instructions 1030.

The one or more servers of the example software distribution platform 1005 are in communication with a network 1010, which may correspond to any one or more of the Internet or other network. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1030 from the software distribution platform 1005 to processor platforms 1020. In some examples, one or more servers of the software distribution platform 1005 periodically offer, transmit, and/or force updates to the software to ensure improvements, patches, updates, etc., are distributed and applied to the software at the end user devices.

The following examples pertain to further embodiments.
In Example 1, one or more non-transitory computer-readable storage mediums have stored thereon instructions that, when executed by one or more processors, cause the one or more processors to perform operations including assigning a thread for a virtual machine (VM) to a virtual processor in a system; assigning the thread to a physical processor of the system for processing; upon determining that the virtual processor is in an idle state, dynamically determining a guest polling time value and performing polling of the virtual processor; and upon receiving an interrupt for the virtual processor prior to a time period for the polling of the virtual processor reaching the determined guest polling time value, returning the thread to processing by the physical processor.
In Example 2, the instructions further include, upon the time period for the polling of the virtual processor exceeding the determined guest polling time value without receiving an interrupt for the virtual processor, issuing a halt instruction for the virtual processor and generating a VM exit to a virtual machine monitor (VMM).
In Example 3, the instructions further include establishing the guest polling time value based at least in part on power state residency values for one or more physical processors.
In Example 4, the instructions further include populating a memory table with the guest polling time, wherein dynamically determining the guest polling time value includes obtaining the guest polling time from the memory table.
In Example 5, the instructions further include receiving a VM exit from the VM at a virtual machine monitor (VMM); switching from the VM to VMM operation; dynamically determining a KVM (Kernel-based Virtual Machine) polling time value for the thread and performing polling of the virtual processor; and, upon receiving an interrupt for the virtual processor prior to a time period for the polling of the virtual processor reaching the determined KVM polling time value, returning the thread to processing by the physical processor.
In Example 6, the instructions further include, upon the time period for the polling of the virtual processor exceeding the determined KVM polling time value without receiving an interrupt for the virtual processor, scheduling out the virtual processor to a host system.
In Example 7, dynamically determining the KVM polling time value for the thread includes determining a classification of the thread, and establishing the KVM polling time value based on the classification.
In Example 8, the classification of the thread includes whether the thread is performance intensive, and wherein a longer KVM polling time is established upon determining that the thread is performance intensive.
In Example 9, a method includes assigning a thread for a virtual machine (VM) to a virtual processor in a system; assigning the thread to a physical processor of the system for processing; upon determining that the virtual processor is in an idle state, dynamically determining a guest polling time value and performing polling of the virtual processor; and, upon receiving an interrupt for the virtual processor prior to a time period for the polling of the virtual processor reaching the determined guest polling time value, returning the thread to processing by the physical processor.
In Example 10, the method further includes, upon the time period for the polling of the virtual processor exceeding the determined guest polling time value without receiving an interrupt for the virtual processor, issuing a halt instruction for the virtual processor and generating a VM exit to a virtual machine monitor (VMM).
In Example 11, the method further includes establishing the guest polling time value based at least in part on power state residency values for one or more physical processors; and populating a memory table with the guest polling time, wherein dynamically determining the guest polling time value includes obtaining the guest polling time from the memory table.
In Example 12, the method further includes receiving a VM exit from the VM at a virtual machine monitor (VMM); switching from the VM to VMM operation; dynamically determining a KVM (Kernel-based Virtual Machine) polling time value for the thread and performing polling of the virtual processor; and upon receiving an interrupt for the virtual processor prior to a time period for the polling of the virtual processor reaching the determined KVM polling time value, returning the thread to processing by the physical processor.
In Example 13, the method further includes, upon the time period for the polling of the virtual processor exceeding the determined KVM polling time value without receiving an interrupt for the virtual processor, scheduling out the virtual processor to a host system.
In Example 14, dynamically determining the KVM polling time value for the thread includes determining a classification of the thread, and establishing the KVM polling time value based on the classification.
In Example 15, the classification of the thread includes whether the thread is performance intensive, and wherein a longer KVM polling time is established upon determining that the thread is performance intensive.
In Example 16, an apparatus includes a plurality of processors, including a plurality of physical central processing units (pCPUs); and memory to store data for virtual processing, wherein one or more processors are to: assign a thread for a virtual machine (VM) to a virtual central processing unit (vCPU) in the apparatus; assign the thread to a pCPU of the plurality of pCPUs for processing; upon determining that the vCPU is in an idle state, dynamically determine a guest polling time value and performing polling of the virtual processor; upon receiving an interrupt for the vCPU prior to a time period for the polling of the vCPU reaching the determined guest polling time value, return the thread to processing by the pCPU; and, upon the time period for the polling of the vCPU exceeding the determined guest polling time value without receiving an interrupt for the virtual processor, issue a halt instruction for the virtual processor and generating a VM exit to a virtual machine monitor (VMM).
In Example 17, the one or more processors are further to establish the guest polling time value based at least in part on power state residency values for the plurality of pCPUs; and populate a memory table with the guest polling time, wherein dynamically determining the guest polling time value includes obtaining the guest polling time from the memory table.
In Example 18, the one or more processors are further to: receive a VM exit from the VM at a virtual machine monitor (VMM); switch from the VM to VMM operation; dynamically determine a KVM (Kernel-based Virtual Machine) polling time value for the thread and performing polling of the virtual processor; upon receiving an interrupt for the virtual processor prior to a time period for the polling of the virtual processor reaching the determined KVM polling time value, return the thread to processing by the physical processor; and, upon the time period for the polling of the virtual processor exceeding the determined KVM polling time value without receiving an interrupt for the virtual processor, schedule out the virtual processor to a host system.
In Example 19, dynamically determining the KVM polling time value for the thread includes determining a classification of the thread, and establishing the KVM polling time value based on the classification.
In Example 20, the classification of the thread includes whether the thread is performance intensive, and wherein a longer KVM polling time is established upon determining that the thread is performance intensive.

Specifics in the Examples may be used anywhere in one or more embodiments.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

1-20. (canceled)

21. One or more non-transitory computer-readable storage mediums having stored thereon instructions that, when executed by one or more processors, cause the one or more processors to perform operations comprising:
assigning a thread for a virtual machine (VM) to a virtual processor in a system;
assigning the thread to a physical processor of the system for processing;
upon determining that the virtual processor is in an idle state, dynamically determining a guest polling time value and performing polling of the virtual processor; and
upon receiving an interrupt for the virtual processor prior to a time period for the polling of the virtual processor reaching the determined guest polling time value, returning the thread to processing by the physical processor.

22. The medium of claim 21, wherein the instructions, when executed, further cause the one or more processors to perform operations comprising:
upon the time period for the polling of the virtual processor exceeding the determined guest polling time value without receiving an interrupt for the virtual processor, issuing a halt instruction for the virtual processor and generating a VM exit to a virtual machine monitor (VMM).

23. The medium of claim 21, wherein the instructions, when executed, further cause the one or more processors to perform operations comprising:
establishing the guest polling time value based at least in part on power state residency values for one or more physical processors.

24. The medium of claim 23, wherein the instructions, when executed, further cause the one or more processors to perform operations comprising:
populating a memory table with the guest polling time, wherein dynamically determining the guest polling time value includes obtaining the guest polling time from the memory table.

25. The medium of claim 21, wherein the instructions, when executed, further cause the one or more processors to perform operations comprising:
receiving a VM exit from the VM at a virtual machine monitor (VMM);
switching from the VM to VMM operation;
dynamically determining a KVM (Kernel-based Virtual Machine) polling time value for the thread and performing polling of the virtual processor; and
upon receiving an interrupt for the virtual processor prior to a time period for the polling of the virtual processor reaching the determined KVM polling time value, returning the thread to processing by the physical processor.

26. The medium of claim 25, wherein the instructions, when executed, further cause the one or more processors to perform operations comprising:
upon the time period for the polling of the virtual processor exceeding the determined KVM polling time value without receiving an interrupt for the virtual processor, scheduling out the virtual processor to a host system.

27. The medium of claim 25, wherein dynamically determining the KVM polling time value for the thread includes determining a classification of the thread, and establishing the KVM polling time value based on the classification.

28. The medium of claim 27, wherein the classification of the thread includes whether the thread is performance intensive, and wherein a longer KVM polling time is established upon determining that the thread is performance intensive.

29. A method comprising:
assigning a thread for a virtual machine (VM) to a virtual processor in a system;
assigning the thread to a physical processor of the system for processing;
upon determining that the virtual processor is in an idle state, dynamically determining a guest polling time value and performing polling of the virtual processor; and
upon receiving an interrupt for the virtual processor prior to a time period for the polling of the virtual processor reaching the determined guest polling time value, returning the thread to processing by the physical processor.

30. The method of claim 29, further comprising:
upon the time period for the polling of the virtual processor exceeding the determined guest polling time value without receiving an interrupt for the virtual processor, issuing a halt instruction for the virtual processor and generating a VM exit to a virtual machine monitor (VMM).

31. The method of claim 29, further comprising:
establishing the guest polling time value based at least in part on power state residency values for one or more physical processors; and
populating a memory table with the guest polling time, wherein dynamically determining the guest polling time value includes obtaining the guest polling time from the memory table.

32. The method of claim 29, further comprising:
receiving a VM exit from the VM at a virtual machine monitor (VMM);
switching from the VM to VMM operation;
dynamically determining a KVM (Kernel-based Virtual Machine) polling time value for the thread and performing polling of the virtual processor; and
upon receiving an interrupt for the virtual processor prior to a time period for the polling of the virtual processor reaching the determined KVM polling time value, returning the thread to processing by the physical processor.

33. The method of claim 32, further comprising:
upon the time period for the polling of the virtual processor exceeding the determined KVM polling time value without receiving an interrupt for the virtual processor, scheduling out the virtual processor to a host system.

34. The method of claim 32, wherein dynamically determining the KVM polling time value for the thread includes determining a classification of the thread, and establishing the KVM polling time value based on the classification.

35. The method of claim 34, wherein the classification of the thread includes whether the thread is performance intensive, and wherein a longer KVM polling time is established upon determining that the thread is performance intensive.

36. An apparatus comprising:
a plurality of processors, including a plurality of physical central processing units (pCPUs); and
memory to store data for virtual processing, wherein one or more processors are to:
assign a thread for a virtual machine (VM) to a virtual central processing unit (vCPU) in the apparatus;
assign the thread to a pCPU of the plurality of pCPUs for processing;
upon determining that the vCPU is in an idle state, dynamically determine a guest polling time value and performing polling of the virtual processor;
upon receiving an interrupt for the vCPU prior to a time period for the polling of the vCPU reaching the determined guest polling time value, return the thread to processing by the pCPU; and
upon the time period for the polling of the vCPU exceeding the determined guest polling time value without receiving an interrupt for the virtual processor, issue a halt instruction for the virtual processor and generating a VM exit to a virtual machine monitor (VMM).

37. The apparatus of claim 36, wherein the one or more processors are further to:
establish the guest polling time value based at least in part on power state residency values for the plurality of pCPUs; and
populate a memory table with the guest polling time, wherein dynamically determining the guest polling time value includes obtaining the guest polling time from the memory table.

38. The apparatus of claim 36, wherein the one or more processors are further to:
receive a VM exit from the VM at a virtual machine monitor (VMM);
switch from the VM to VMM operation;
dynamically determine a KVM (Kernel-based Virtual Machine) polling time value for the thread and performing polling of the virtual processor;
upon receiving an interrupt for the virtual processor prior to a time period for the polling of the virtual processor reaching the determined KVM polling time value, return the thread to processing by the physical processor; and
upon the time period for the polling of the virtual processor exceeding the determined KVM polling time value without receiving an interrupt for the virtual processor, schedule out the virtual processor to a host system.

39. The apparatus of claim 38, wherein dynamically determining the KVM polling time value for the thread includes determining a classification of the thread, and establishing the KVM polling time value based on the classification.

40. The apparatus of claim 39, wherein the classification of the thread includes whether the thread is performance intensive, and wherein a longer KVM polling time is established upon determining that the thread is performance intensive.
